(19) United States
(12) Patent Application Publication
(10) Pub. No.: US 2026/0319254 A1
(43) Pub. Date: Oct. 15, 2026

(54) DUAL PROJECTOR SYSTEM AND IMAGE LIGHT GUIDE

(71) Applicant: Vuzix Corporation, West Henrietta, NY (US)

(72) Inventor: Robert J. Schultz, Victor, NY (US)

(21) Appl. No.: 19/117,066

(22) PCT Filed: Sep. 29, 2023
(86) PCT No.: PCT/US2023/034213

§ 371 Date: Mar. 30, 2025

Related U.S. Application Data
(60) Provisional application No. 63/412,294, filed on Sep. 30, 2022.

(51) Int. Cl. G02B 27/01

(52) U.S. Cl. CPC G02B 27/0172

(57) ABSTRACT

An image light guide for conveying a virtual image including a first surface and an opposing second surface, and a first in-coupling diffractive optic arranged along one of the first surface and the second surface, wherein the first in-coupling diffractive comprises a first set of diffractive features. A second in-coupling diffractive optic arranged along one of the first surface and the second surface, wherein the second in-coupling diffractive comprises a second set of diffractive features. The image light guide further including an out-coupling diffractive optic arranged along at least one of the first surface and the second surface, wherein the out-2024/073100 coupling diffractive optic includes a plurality of zones each having a set of diffractive features different than an adjacent zone, wherein the plurality of zones includes a first zone optimized to diffract in-coupled light from both the first and second in-coupling diffractive optics.

### TECHNICAL FIELD

The present disclosure generally relates to electronic displays, and more particularly to optical image light guide systems with diffractive optics operable to convey image-bearing light to a viewer.

### BACKGROUND

Head-Mounted Displays (HMDs) are being developed for a range of diverse uses, including military, commercial, industrial, firefighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

In general, HMD optics must meet a number of basic requirements for viewer acceptance, including pupil size and field of view (FOV). Pupil size requirements are based on physiological differences in viewer face structure as well as on gaze direction during viewing. A minimum entrance pupil diameter of approximately 10 mm has been found to be desirable for general viewers. A wide FOV is preferable for many tasks and operations. Further, the virtual image that is generated should have sufficient brightness for visibility and viewer comfort.

In addition to optical requirements, HMD designs must also address practical factors such as acceptable form factor with expectations of reduced size for wearing comfort, weight, cost, and ease of use. There is thus a need for an image light guide system providing an increased FOV and brightness while maintaining a small form factor.

### SUMMARY

It is an object of the present disclosure to advance the art of virtual image presentation using head-mounted devices. Advantageously, embodiments of the present disclosure provide light coupling solutions that are compatible with the general form factor of eyeglasses.

These and other aspects, objects, features and advantages of the present invention will be more clearly understood and appreciated from the following detailed description of the embodiments and appended claims, and by reference to the accompanying drawings. In an exemplary embodiment, the present disclosure provides an image light guide for conveying a virtual image including a first surface and an opposing second surface, and a first in-coupling diffractive optic arranged along one of the first surface and the second surface, wherein the first in-coupling diffractive comprises a first set of diffractive features. A second in-coupling diffractive optic arranged along one of the first surface and the second surface, wherein the second in-coupling diffractive comprises a second set of diffractive features. The image light guide further including an out-coupling diffractive optic arranged along at least one of the first surface and the second surface, wherein the out-coupling diffractive optic includes a plurality of zones each having a set of diffractive features different than an adjacent zone, wherein the plurality of zones includes a first zone optimized to diffract in-coupled light from both the first and second in-coupling diffractive optics.

In an exemplary embodiment, the out-coupling diffractive optic comprises the first zone, a second zone arranged outward of the first zone in a first direction, a third zone arranged outward of the second zone in the first direction, a fourth zone arranged outward of the first zone in a second direction, and a fifth zone arranged outward of the fourth zone in the second direction.

In an exemplary embodiment, the second zone and the fourth zone are mirrored across the first zone, and the third zone and the fifth zone are mirrored across the first zone.

In an exemplary embodiment, the second and fourth zones are rectilinear and oriented at opposite angles relative to an imaginary axis bisecting the first zone.

In an exemplary embodiment, the first zone comprises linear diffractive features orientated parallel with an imaginary axis arranged to bisect the first surface and is parallel with the first surface, wherein the imaginary axis extends between a first edge of the first surface adjacent to the first in-coupling diffractive optic and the second in-coupling diffractive optic and a second edge of the first surface adjacent to the out-coupling diffractive optic.

In an exemplary embodiment, the third zone comprises linear diffractive features oriented at a first angle relative to the diffractive features of the first zone, and the fifth zone comprises linear diffractive features oriented at a second angle relative to the diffractive features of the first zone. For example, the second angle may be equal and opposite the first angle.

In an exemplary embodiment, the second zone comprises a first set of linear diffractive features parallel with the diffractive features of the first zone, and a second set of linear diffractive features parallel with the diffractive features of the third zone.

In an exemplary embodiment, the fourth zone comprises a first set of linear diffractive features parallel with the diffractive features of the first zone, and a second set of linear diffractive features parallel with the diffractive features of the fifth zone.

In an exemplary embodiment, the second zone comprises diffractive features having a first grating vector parallel with a grating vector of the first zone, and a second grating vector parallel with a grating vector of the third zone; and wherein the fourth zone comprises diffractive features having a first grating vector parallel with the grating vector of the first zone, and a second grating vector parallel with a grating vector of the fifth zone.

In an exemplary embodiment, the first, second, third, and fourth zones of the out-coupling diffractive optic form a first output region optimized to diffract image-bearing light beams in-coupled by the first in-coupling diffractive optic, and the first, second, fourth, and fifth zones of the out-coupling diffractive optic form a second output region optimized to diffract image-bearing light beams in-coupled by the second in-coupling diffractive optic.

In an exemplary embodiment, the present disclosure provides for an image source for generating angularly encoded image-bearing light beams, the image source including a light source system, a first beam splitter having two opposing output sides through which polarized portions of light exit the polarizing beam splitter, wherein the polarizing beam splitter is operable to polarize light from the light source system into a first optical path and a second optical path, a second beamsplitter arranged in the first optical path to receive light emitted from the first beam splitter, a third beamsplitter arranged in the second optical path to receive light emitted from the first beam splitter, and a first imaging engine arranged in the first optical path to receive light from the second beamsplitter, and a second imaging engine arranged in the second optical path to receive light from the third beamsplitter.

In an exemplary embodiment, the light source system includes a first wavelength source, a second wavelength source, and a third wavelength source, wherein the first, second, and third wavelength sources are operable to emit light incident upon the first beam splitter.

In an exemplary embodiment, the light source system further includes lenses arranged between the wavelength sources, respectively, to collimate light emitted thereby.

In an exemplary embodiment, the first beam splitter includes a polarizing beam splitter operable to split unpolarized light from the light source system into linearly polarized light.

In an exemplary embodiment, the image source includes a first prism arranged in the first optical path, and a second prism arranged in the second optical path the first and second prisms are operable to direct the polarized light along the first and second optical paths, respectively.

In an exemplary embodiment, the first and second imaging engines comprise liquid crystal on silicon (LCOS) panels. For example, the LCOS panels are front lit.

In an exemplary embodiment, the first and second imaging engines comprise digital light processing (DLP) projectors.

In an exemplary embodiment, a first wave plate is arranged to reorient the polarization of light emitted by the first imaging engine, and a second wave plate arranged to reorient the polarization of light emitted by the second imaging engine.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and out-coupling diffractive optic for managing the propagation of image-bearing light beams.

FIG. 3A is a side view of an image light guide according to an exemplary embodiment of the presently disclosed subject matter.

FIG. 3B is a side view of an embodiment of the image light guide according to FIG. 3A.

FIG. 4A is a top view of an embodiment of the image light guide, with an exaggerated thickness, according to FIG. 3A.

FIG. 4B is a top view of another embodiment of the image light guide, with an exaggerated thickness, according to FIG. 3A.

FIG. 4C is a top view of yet another embodiment of the image light guide, with an exaggerated thickness, according to FIG. 3A.

FIG. 5 is a side view of an image light guide including a waveguide stack according to an exemplary embodiment of the presently disclosed subject matter.

FIG. 6A is a top perspective view of an image light guide with image sources according to an exemplary embodiment of the presently disclosed subject matter.

FIG. 6B is a schematic top perspective view of an image light guide with image sources according to an exemplary embodiment of the presently disclosed subject matter.

FIG. 7 is a schematic top view of an image source system according to an exemplary embodiment of the presently disclosed subject matter.

FIG. 8 is a front view of the image source system according to FIG. 7.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment,” “an exemplary embodiment,” or “an embodiment” means that a particular feature, structure, or characteristic described in connection with the embodiment is included in at least one embodiment of the present disclosure. Thus, the appearance of the phrase “in one embodiment,” “in an exemplary embodiment,” or “in an embodiment” throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, “wearer”, and “user” are considered equivalents and refer to the person, or machine, that wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the terms “wavelength band” and “wavelength range” are equivalent and have their standard connotation as used by those skilled in the art of color imaging and refer to a continuous range of light wavelengths that are used to represent polychromatic images.

Where used herein, the term “beam expansion” is intended to mean replication of a beam via multiple encounters with an optical element to provide exit pupil expansion in one or more dimensions. Similarly, as used herein, to “expand” a beam, or a portion of a beam, is intended to mean replication of a beam via multiple encounters with an optical element to provide exit pupil expansion in one or more dimensions.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

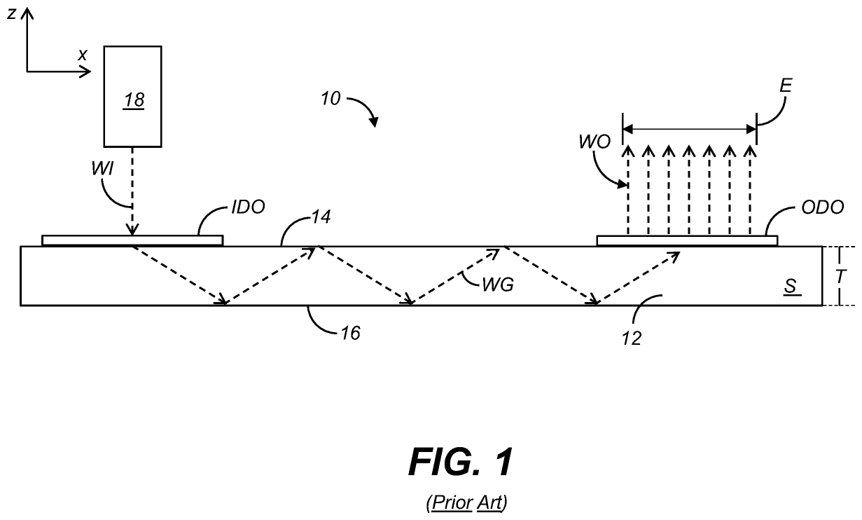

FIG. 1 is a schematic diagram showing a simplified cross-sectional view of one conventional configuration of an image light guide system 10. Image light guide system 10 includes a planar image light guide 12, an in-coupling diffractive optic IDO, and an out-coupling diffractive optic ODO. The image light guide 12 includes a transparent substrate S, which can be made of optical glass or plastic, with plane-parallel front and back surfaces 14 and 16. In this example, the in-coupling diffractive optic IDO is shown as a transmissive-type diffraction grating arranged on, in, or otherwise engaged with the front surface 14 of the image light guide 12. However, in-coupling diffractive optic IDO could alternately be a reflective-type diffraction grating or other type of diffractive optic, such as a volume hologram or other holographic diffraction element, that diffracts incoming image-bearing light beams WI into the image light guide 12. The in-coupling diffractive optic IDO can be located on, in, or otherwise engaged with front surface 14 or back surface 16 of the image light guide 12 and can be of a transmissive or reflective-type in a combination that depends upon the direction from which the image-bearing light beams WI approach the image light guide 12.

When used as a part of a near-eye or head-mounted display system, the in-coupling diffractive optic IDO of the conventional image light guide system 10 couples the image-bearing light beams WI from a real, virtual or hybrid image source 18 into the substrate S of the image light guide 12. Any real image or image dimension formed by the image source 18 is first converted into an array of overlapping, angularly related, collimated beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar image light guide 12 as angularly encoded image-bearing light beams WG for further propagation along a length dimension x of the image light guide 12 by total internal reflection (TIR) between the plane-parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) at least a portion of the image-bearing light beams WG out of the image light guide 12, as image-bearing light beams WO, toward a nearby region of space referred to as an eyebox E, within which the transmitted virtual image can be seen by a viewer's eye or other optical component. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the image light guide 12 to encounter the image-bearing light beams WG multiple times and to diffract only a portion of the image-bearing light beams WG upon each encounter. The multiple encounters along the length (e.g., a first direction) of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

The out-coupling diffractive optic ODO is shown as a transmissive-type diffraction grating arranged on or secured to the front surface 14 of the image light guide 12. However, like the in-coupling diffractive optic IDO, the out-coupling diffractive optic ODO can be located on, in, or otherwise engaged with the front or back surface 14 or 16 of the image light guide 12 and can be of a transmissive or reflective-type in a combination that depends upon the direction through which the image-bearing light beams WG is intended to exit the image light guide 12. In addition, the out-coupling diffractive optic ODO could be formed as another type of diffractive optic, such as a volume hologram or other holographic diffraction element, that diffracts propagating image-bearing light beams WG from the image light guide 12 as the image-bearing light beams WO propagating toward the eyebox E.

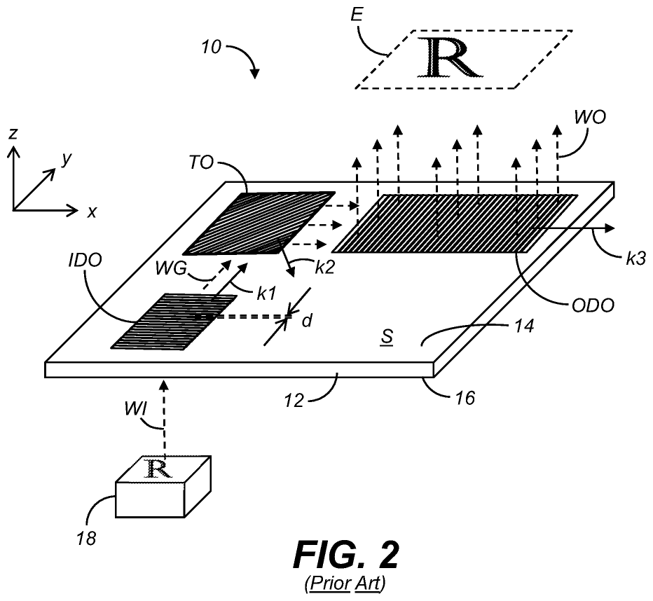

FIG. 2 illustrates a perspective view of a conventional image light guide system 10 arranged for expanding the eyebox E in two dimensions, i.e., along both x- and y-axes of the intended image. To achieve a second dimension of eyebox expansion, the in-coupling diffractive optic IDO is oriented to diffract at least a portion of image-bearing light beams WG along a grating vector k1 along the image light guide 12 toward an intermediate turning optic TO, whose grating vector k2 is oriented to diffract at least a portion of the image-bearing light beams WG in a reflective mode along the image light guide 12 toward the out-coupling diffractive optic ODO. It should be appreciated that only a portion of the image-bearing light beams WG are diffracted by each of the multiple encounters with intermediate turning optic TO, thereby laterally replicating each of the angularly related beams of the image-bearing light beams WG as they approach the out-coupling diffractive optic ODO. The intermediate turning optic TO redirects the image-bearing light beams WG toward the out-coupling diffractive optic ODO (having a grating vector k3) for longitudinally replicating the angularly related beams of the image-bearing light beams WG in a second direction before exiting the image light guide 12 as the image-bearing light beams WO. Grating vectors, such as the depicted grating vectors k1, k2, and k3, extend within a parallel plane of the image light guide 12 in respective directions that are normal to the diffractive features (e.g., grooves, lines, or rulings) of the diffractive optics and have respective magnitudes inverse to the period or pitch d (i.e., the on-center distance between the diffractive features) of the diffractive optics IDO, TO, and ODO.

As shown in FIG. 2, in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with collimating optics or other optical components, by a beam scanner for more directly setting the angles of the beams, or by a combination such as a one-dimensional real display used with a scanner. In this configuration, the image light guide 12 outputs a replicated set of angularly related beams (replicated in two dimensions) by providing multiple encounters of the image-bearing light beams WG with both the intermediate turning optic TO and the out-coupling diffractive optic ODO in different orientations. In the depicted orientation of the image light guide 12, the intermediate turning optic TO provides eyebox expansion in a first dimension, e.g., the y-axis direction, and the out-coupling diffractive optic ODO provides a similar eyebox expansion in a second dimensions, e.g., the x-axis direction. The relative orientations and respective periods d of the diffractive features of the in-coupling optic IDO, intermediate turning optic TO, and out-coupling diffractive optic ODO provide for eyebox expansion in two dimensions while preserving the intended relationships among the angularly related beams of the image-bearing light beams WI that are output from the image light guide system 10 as the image-bearing light beams WO. It should be appreciated that the periods d of the in-coupling diffractive optic IDO, the intermediate turning optic TO, and the out-coupling diffractive optic ODO, can each include diffractive features having a common pitch d, where the common pitch d of each optic can be different.

In the configuration shown, while the image-bearing light beams WI input into the image light guide 12 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period d. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG are turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. By basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the image light guide 12 are effectively encoded by the in-coupling diffractive optic IDO, whether the in-coupling optic IDO uses gratings, holograms, prisms, mirrors, or some other mechanism. Any reflection, refraction, and/or diffraction of light that takes place at the input should be correspondingly decoded by the output to re-form the virtual image that is presented to the viewer. Whether any symmetries are maintained among the intermediate turning optic TO, the in-coupling optic IDO, and out-coupling diffractive optic ODO, or whether any change to the encoding of the angularly related beams of the image-bearing light beams WI takes place along the image light guide 12, the intermediate turning optic TO and the in-coupling and out-coupling diffractive optics IDO and ODO can be related so that the image-bearing light beams WO that are output from the image light guide 12 preserve or otherwise maintain the original or desired form of the image-bearing light beams WI for producing the intended virtual image.

As shown in FIG. 2, the letter “R” represents the orientation of the virtual image that is visible to the viewer whose eye is positioned within the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing one dimension of eyebox expansion through replication of the angularly encoded beams of the image-bearing light beams WG along one axis (e.g., along the y-axis) of the image. Out-coupling diffractive optic ODO further provides a second dimension of eyebox expansion through replication of the angularly encoded beams along another axis (e.g., along the x-axis) while maintaining the original orientation of the virtual image encoded by the image-bearing light beams WI. The intermediate turning optic TO is typically a slanted or square grating or, alternately, can be a blazed grating and is typically arranged on one of the plane-parallel front and back surfaces of the image light guide 12. It should be appreciated that the representation of the virtual image “R” as created by an image source is comprised of infinitely focused light that requires a lens (e.g., the lens in the human eye) to focus the image so that the orientations discussed above can be detected.

Together, the in-coupling, turning, and out-coupling diffractive optics IDO, TO, and ODO preferably preserve the angular relationships among beams of different wavelengths defining a virtual image upon conveyance by image light guide 12 from an offset position to a near-eye position of the viewer. While doing so, the in-coupling, turning, and out-coupling diffractive optics IDO, TO, and ODO can be relatively positioned and oriented in different ways to control the overall shape of the image light guide 12 as well as the overall orientations at which the angularly related beams can be directed into and out of the image light guide 12.

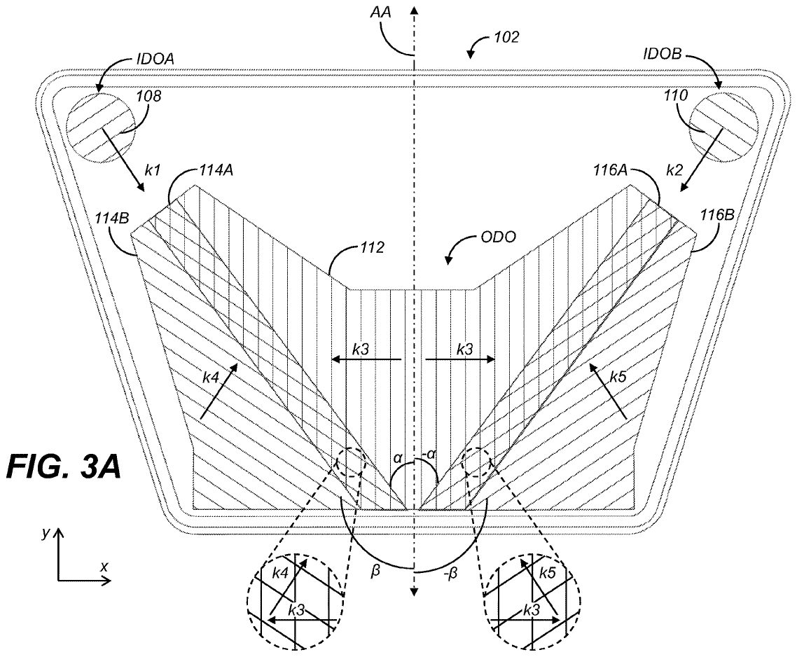

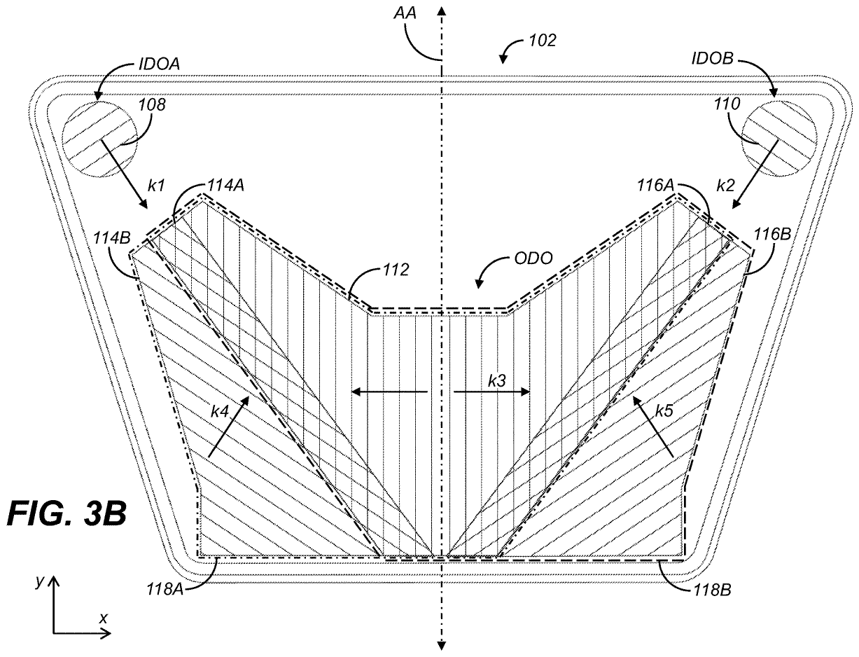

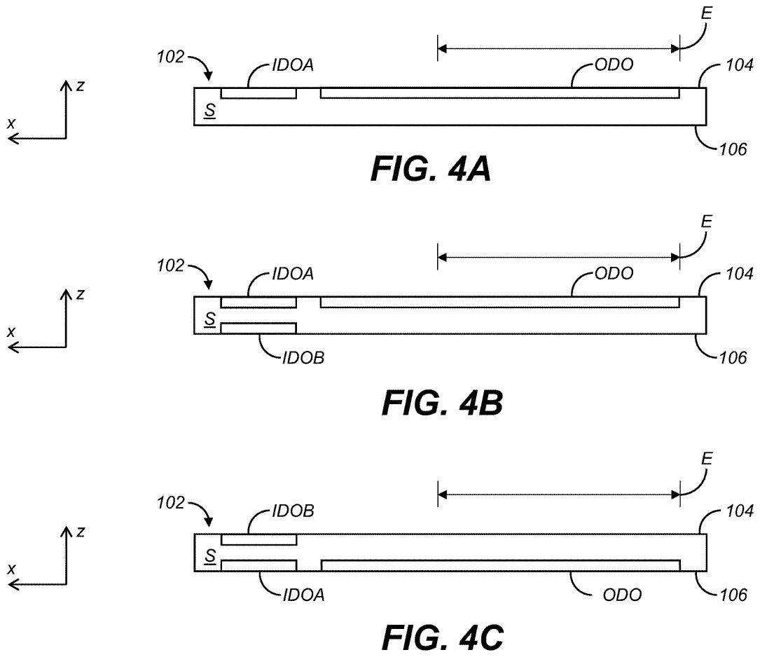

FIG. 3A shows an exemplary embodiment of a waveguide 102 according to the present disclosure. In an example embodiment, the waveguide 102 includes an at least partially transparent substrate S (see FIGS. 4A-4C) with plane-parallel front and back surfaces 104 and 106 (also shown in FIGS. 4A-4C). For example, the waveguide 102 may be made of optical glass or plastic. The waveguide 102 includes a first in-coupling diffractive optic IDOA and a second in-coupling diffractive optic IDOB. In one example, the first in-coupling diffractive optic IDOA and the second in-coupling diffractive optic IDOB can be laterally offset (i.e., in the x-or y-direction) with respect to each other and can be arranged on the front and/or back surfaces 104, 106. In another example, the first in-coupling diffractive optic IDOA and the second in-coupling diffractive optic IDOB are laterally offset with respect to each other and at least one of the first or second in-coupling diffractive optics IDOA, IDOB is arranged on the front surface 104 and the other of the first or second in-coupling diffractive optics IDOA, IDOB is arranged on the back surface 106. As illustrated in FIG. 3A, in an exemplary embodiment, the first in-coupling diffractive optic IDOA and the second in-coupling diffractive optic IDOB are symmetrically arranged about an imaginary axis AA which bifurcates the waveguide 102. In an example, the imaginary axis AA bisects the waveguide 102. As illustrated in FIG. 3A, the first in-coupling diffractive optic IDOA includes a first diffractive pattern 108 and the second in-coupling diffractive optic IDOB includes a second diffractive pattern 110. The first diffractive pattern 108 includes a plurality of diffractive features periodic in at least a first direction expressed by the grating vector k1. The second diffractive pattern 110 includes another plurality of diffractive features periodic in at least a second direction expressed by the grating vector k2. For example, the first and second diffractive patterns 108, 110 may comprise linear diffractive features. Although other shapes are possible, waveguide 102 is formed generally as an inverted trapezoid, e.g., where first in-coupling diffractive optic IDOA and the second in-coupling diffractive optic IDOB are arranged proximate the longer of the two parallel sides of the trapezoid.

With continued reference to FIG. 3A, in an example embodiment, the waveguide 102 includes an out-coupling diffractive optic ODO having a plurality of zones of diffractive features, e.g., a first zone 112, a second zone 114A, a third zone 114B, a fourth zone 116A, and a fifth zone 116B of diffractive features. The out-coupling diffractive optic ODO is symmetrically arranged about the imaginary axis AA. In an example embodiment, the first zone 112 defines a generally V-shaped and/or triangular area and is centrally arranged within the out-coupling diffractive optic ODO such that the imaginary axis AA bifurcates the first zone 112. The second zone 114A is arranged outward of the first zone 112 in the-x-axis direction (e.g., to the left in FIG. 3A) and the third zone 114B is arranged outward of the second zone 114A in the -x-axis direction (e.g., to the left in FIG. 3A). The fourth zone 116A and the fifth zone 116B are mirrored across a plane having a surface parallel to the imaginary axis AA with respect to the second zone 114A and the third zone 114B, respectively. In an example embodiment, the second and fourth zones 114A, 116A are generally rectilinear in shape and are oriented at an angle +a, respectively, relative to the imaginary axis AA. The third and fifth zones 114B, 116B may comprise generally triangular shapes.

In an example embodiment, the diffractive features of the first zone 112 approximate straight line diffractive features oriented parallel to the imaginary axis AA and having a grating vector ±kl , the diffractive features of the third zone 114B approximate straight line diffractive features oriented at an angle β relative to the diffractive features of the first zone 112 and having a grating vector k4, the diffractive features of the fifth zone 116B approximate straight line diffractive features oriented at an angle −β relative to the diffractive features of the first zone 112 and having a grating vector k5. The second zone 114A includes diffractive features defining grating vectors k3 and k4. For example, the second zone 114A includes the overlapping diffractive features of the first zone 112 (having a grating vector k3) and the third zone 114B (having grating vector k4). Similarly, the fourth zone 116A includes diffractive features defining grating vectors k3 and k5. For example, the fourth zone 116A includes the overlapping diffractive features of the first zone 112 (having grating vector k3) and the fifth zone 116B (having grating vector k5).

In one example embodiment, the first, second, third, and fourth zones 112, 114A, 114B, 116A of the out-coupling diffractive optic ODO are optimized to diffract image-bearing light beams in-coupled by the first in-coupling diffractive optic IDOA and the first, second, fourth, and fifth zones, 112, 114A, 116A, 116B of the out-coupling diffractive optic ODO are optimized to diffract image-bearing light beams in-coupled by the second in-coupling diffractive optic IDOB. Thus, image-bearing light beams in-coupled by the first in-coupling diffractive optic IDOA and the second in-coupling diffractive optic IDOB utilize at least the diffractive features of the central first zone 112 in their optical path to the eyebox E. In other examples, the image-bearing light beams in-coupled by the first in-coupling diffractive optic IDOA and the second in-coupling diffractive optic IDOB utilize the diffractive features of the first zone 112, the second zone 114A, and the fourth zone 116A.

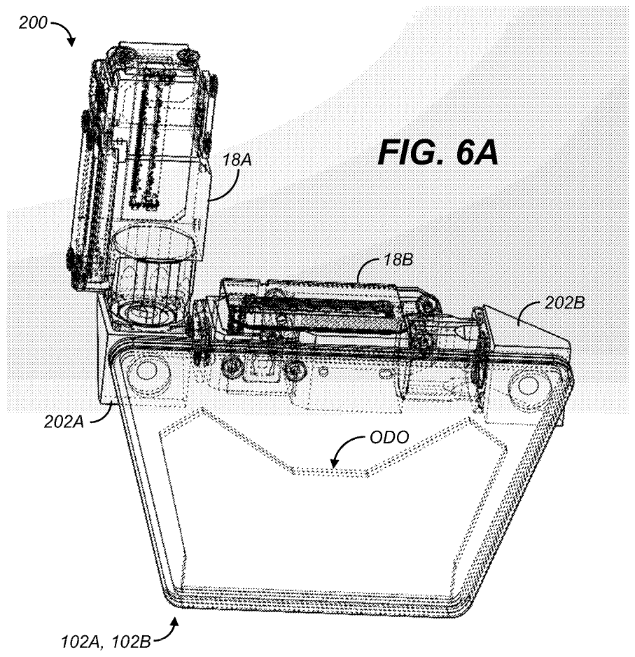

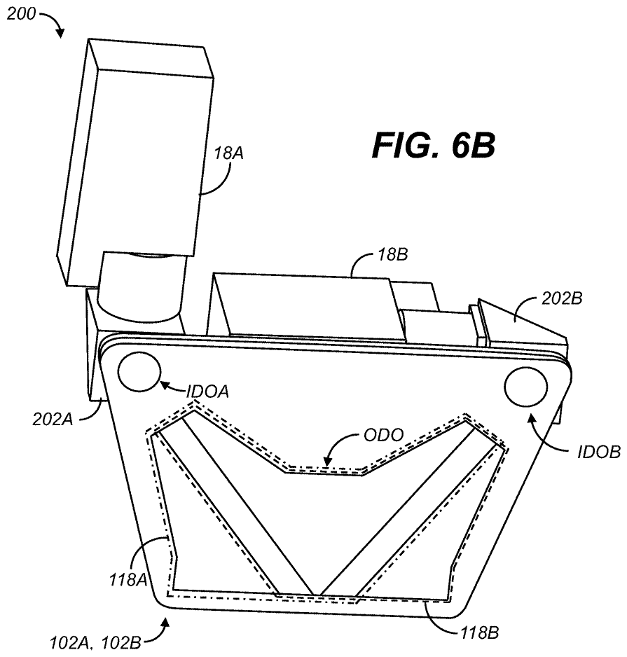

Referring now to FIGS. 3B and 6B, the first, second, third, and fourth zones 112, 114A, 114B, 116A of the out-coupling diffractive optic ODO may form a first output region 118A optimized to diffract image-bearing light beams in-coupled by the first in-coupling diffractive optic IDOA. The first, second, fourth, and fifth zones, 112, 114A, 116A, 116B of the out-coupling diffractive optic ODO may form a second output region 118B optimized to diffract image-bearing light beams in-coupled by the second in-coupling diffractive optic IDOB.

In an example embodiment, the second zone 114A of the out-coupling diffractive optic ODO includes diffractive features comprising generally diamond-shaped posts where each diamond-shaped post includes two sides arranged generally parallel with the diffractive features of the first zone 112 (e.g., perpendicular to the grating vector k3) and two sides generally parallel with the diffractive features of the third zone 114B (e.g., perpendicular to the grating vector k4). Similarly, the fourth zone 116A may include diffractive features comprising generally diamond-shaped posts where each diamond-shaped post includes two sides generally parallel with the diffractive features of the first zone 112 (e.g., perpendicular to the grating vector k3) and two sides generally parallel with the diffractive features of the fifth zone 116B (e.g., perpendicular to the grating vector k5).

With continued reference to FIG. 3A, in an exemplary embodiment, the waveguide 102 provides a first optical path for a first wavelength range of light (e.g., red light in a wavelength range of 620-750 nm) through the first in-coupling diffractive optic IDOA and the first, second, third, and fourth zones 112, 114A, 114B, 116A of the out-coupling diffractive optic ODO, and a second optical path for a second, different, wavelength range of light (e.g., green light in a wavelength range of 500-565 nm) through the second in-coupling diffractive optic IDOB and the first, second, fourth, and fifth zones 112, 114A, 116A, 116B of the out-coupling diffractive optic ODO. The zoned out-coupling diffractive optic ODO enables the waveguide 102 to utilize the same pattern of diffractive features in the first zone 112 (as well as the diffractive features in the second and fourth zones 114A, 116A) for both optical paths. With regards to alignment of virtual images, utilizing the same pattern of diffractive features in the first zone 112, second zone 114A, and fourth zone 116A, for both optical paths prevents a disconnect in the waveguide 102 where the image-bearing light meets without physically overlapping diffractive optic (e.g., diffraction grating) areas.

Additionally, the diffractive features in first zone 112 and some of the diffractive features in the second and fourth zones 114A, 116A of the out-coupling diffractive optic ODO are vertically oriented (i.e., oriented parallel with the imaginary axis AA) to prevent image noise created by overhead point sources when in use. In other words, the vertical orientation of the diffractive features in first zone 112 (and in at least some examples the second zone 114A and the fourth zone 116A) prevents, or mitigates against, overhead point sources inducing “rainbows.” Referring now to FIG. 4A, in an example embodiment, the first in-coupling diffractive optic IDOA, the second in-coupling diffractive optic IDOB, and the out-coupling diffractive optic ODO are arranged on the front surface 104 of the waveguide 102. Similarly, in another example embodiment, the first in-coupling diffractive optic IDOA, the second in-coupling diffractive optic IDOB, and the out-coupling diffractive optic ODO may be arranged on the back surface 106 of the waveguide 102. In yet another embodiment, the first in-coupling diffractive optic IDOA and the second in-coupling diffractive optic IDOB are arranged on the front surface 104 of the waveguide 102, and the out-coupling diffractive optic ODO is arranged on the back surface 106 of the waveguide 102. Referring now to FIG. 4B, in an example embodiment, the first in-coupling diffractive optic IDOA is arranged on the front surface 104 and the second in-coupling diffractive optic IDOB is arranged on the back surface 106 of the waveguide 102. Similarly, as illustrated in FIG. 4C, in an example embodiment, the first in-coupling diffractive optic IDOA may be arranged on the back surface 106 and the second in-coupling diffractive optic IDOB may be arranged on the front surface 104 of the waveguide 102.

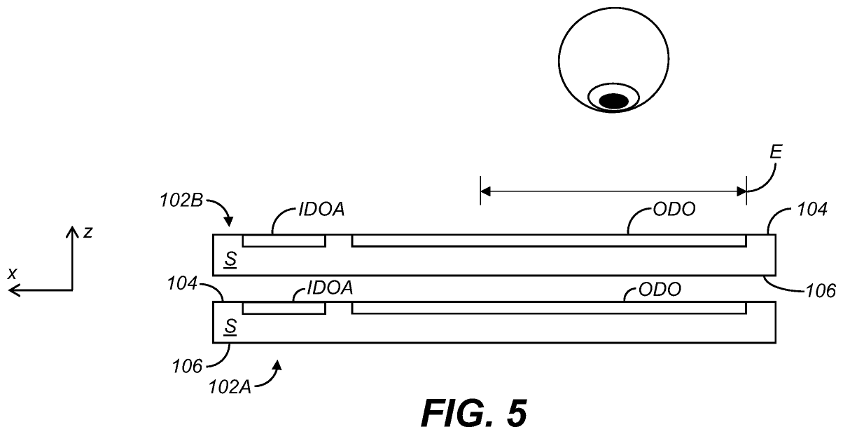

Referring now to FIG. 5, utilizing two waveguides, e.g., first waveguide 102A and a second waveguide 102B in a waveguide stack forms six effective diffractive areas and facilitates conveying a polychromatic image to the eyebox E. For example, a first waveguide 102A can include two in-coupling diffractive optics IDOA and IDOB where the diffractive features within both in-coupling diffractive optics IDOA, IDOB of the first waveguide 102A are optimized to in-couple image-bearing light beams of a first wavelength range, e.g., red light, while a second waveguide 102B can include two in-coupling diffractive optics IDOA and IDOB where the diffractive features within both in-coupling diffractive optics IDOA, IDOB of the second waveguide 102B are optimized to in-couple image-bearing light beams of a second, different, wavelength range, e.g., green light and/or blue light. In these examples, the first in-coupling diffractive optic IDOA of the first waveguide 102A and the first in-coupling diffractive optic IDOA of the second waveguide 102B are coaxial about an imaginary axis arranged through both first in-coupling diffractive optics IDOA and through both planar surfaces of the first waveguide 102A (e.g., the imaginary axis is oriented normal to the planar surfaces of the waveguides). Similarly, the second in-coupling diffractive optic IDOB of the first waveguide 102A and the second in-coupling diffractive optic IDOB of the second waveguide 102B are coaxial about an imaginary axis arranged through both second in-coupling diffractive optics IDOB and through both planar surfaces of the first waveguide 102A (e.g., the imaginary axis is oriented normal to the planar surfaces of the waveguides). As such, two image sources or a single image source with split exit pupils can utilize six different diffractive zones or regions (e.g., diffractive optics) to form a fully polychromatic virtual image with a wide FOV utilizing two waveguides in a single waveguide stack.

Referring now to FIGS. 6A and 6B, in an exemplary embodiment, an image light guide system 200 including the waveguide 102, 102A, 102B, or 102A and 102B also includes two image sources 18A, 18B. As illustrated in FIGS. 6A and 6B, one or more optical couplers 202 such as, without limitation, prisms may be utilized to direct image-bearing light to the in-coupling diffractive optics IDOA, IDOB, respectively. The first image source 18A directs, for example via optical coupler 202A, a first portion of image-bearing light to the first in-coupling diffractive optic IDOA. The second image source 18B directs, for example via optical coupler 202B, a second portion of image-bearing light to the second in-coupling diffractive optic IDOB. In an exemplary embodiment, the first and second image sources 18a, 18B are arranged at transverse orientations relative to each other. For example, the first image source 18A may be arranged generally parallel with the imaginary axis AA (shown in FIG. 3A) and the second image source 18B may be arranged generally orthogonal to the first image source 18A.

In an exemplary embodiment, the first image source 18A is operable to emit image-bearing light corresponding to a first half of the field of view (FOV) of the image conveyed to the eyebox and the second image source 18B is operable to emit image-bearing light corresponding to a second half of the field of view (FOV) of the image conveyed to the eyebox. The first in-coupling diffractive optic IDOA is optimized to diffract the image-bearing light from the image source 18A and the second in-coupling diffractive optic IDOB is optimized to diffract the image-bearing light from the image source 18B. This arrangement enables each in-coupling diffractive optic IDOA, IDOB to diffract half the image conveyed to the eyebox into the waveguide 102 which are combined into a single, wide FOV virtual image upon out-coupling from the out-coupling diffractive optic ODO. This provides the advantage of doubling the FOV of the image conveyed to the user without compromising brightness of the virtual image. In an exemplary embodiment, the FOV emitted by each image source 18A, 18B may be greater than half of the total FOV such that the FOV emitted by each image source 18A, 18B overlaps within the eyebox.

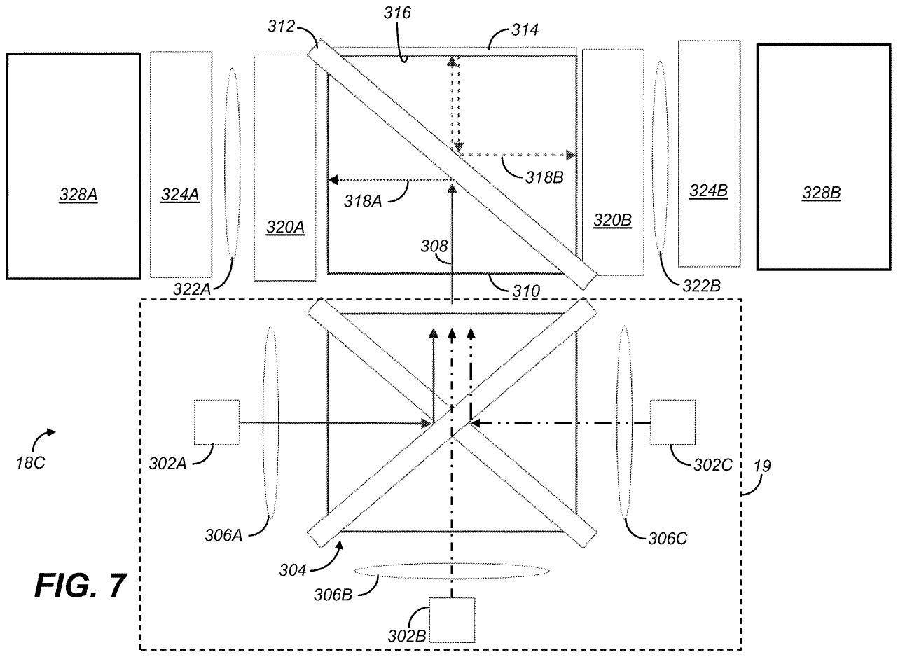

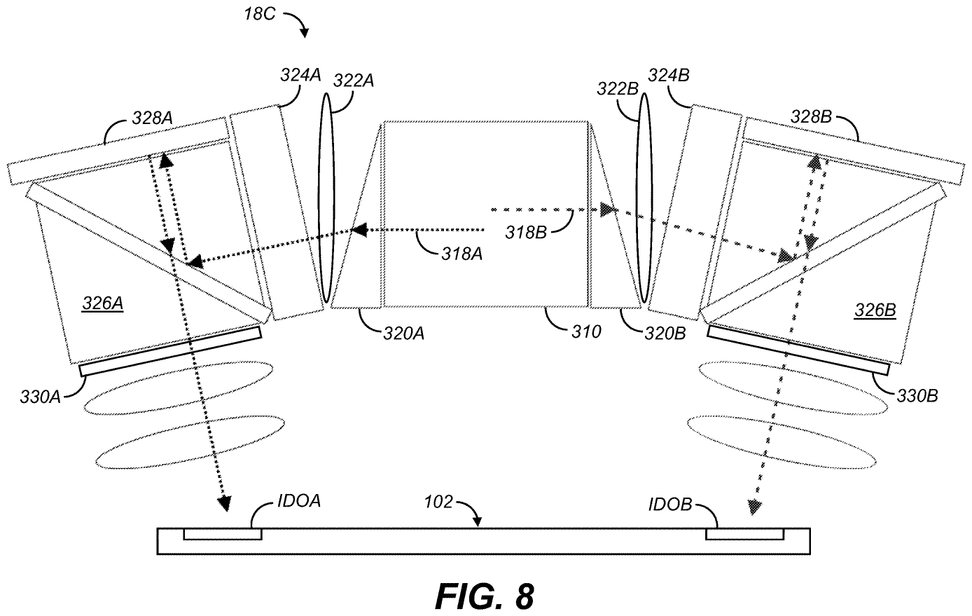

Referring now to FIGS. 7 and 8, in an exemplary embodiment, an image light guide system 200 including the waveguide 102 includes an image source 18C having a light source system 19. The light source system 19 may include a first wavelength source 302A (e.g., red wavelength range source), a second wavelength source 302B (e.g., green wavelength range source), and a third wavelength source 302C (e.g., blue wavelength range source) operable to emit light incident upon a combiner 304 such as an X-cube. Lenses 306A, 306B, 306C arranged between the wavelength sources 302A, 302B, 302C, respectively, may be utilized to collimate the light emitted by the wavelength sources 302A, 302B, 302C. For example, the lenses 306A, 306B, 306C may, without limitation, be formed of glass or plastic.

In an example embodiment, the image source 18C includes a polarizing beam splitter 310. Unpolarized light 308 is emitted from the combiner 304 of the light source system 19 and is incident upon the polarizing beam splitter 310. The polarizing beam splitter 310 is configured to split the light path by polarization. In an example embodiment, the polarizing beam splitter 310 comprises a cube beam splitter having a polarizing coating 312 arranged along a diagonal of the cube and a reflector coating paired with a quarter wave plate 314 (e.g., at 45°) arranged along a surface 316 of the cube, wherein the surface 316 is arranged transverse to the path of the unpolarized light 308.

For example, the polarizing beam splitter 310 splits the unpolarized light 308 into S-polarized light 318A and P-polarized light 318B. The portions of linearly polarized light 318A, 318B are emitted from opposing sides of the polarizing beam splitter 310 and are incident upon a first prism 320A and a second prism 320B, respectively. In an example embodiment, the first and second prisms 320A, 320B are operable to direct the linearly polarized light 318A, 318B to a desired nominal angular path. For example, the first and second prisms 320A, 320B may be wedge prisms.

As illustrated in FIG. 7, in an example embodiment, the image source 18C includes lenses 322A, 322B arranged optically between the polarizing beam splitter 310 and homogenizing elements 324A, 324B. The lenses 322A, 322B are utilized in conjunction with the lenses 306A, 306B, 306C to collimate the light emitted by the wavelength sources 302A, 302B, 302C. The homogenizing elements 324A, 324B are configured to make the pupil more uniform. For example, the homogenizing elements 324A, 324B may be light pipes, lenslet arrays, or scattering elements.

Referring now to FIG. 8 which illustrates a top-plan schematic view of image source 18C, in an example embodiment, the image source 18C includes beamsplitters 326A, 326B arranged in the optical path to intercept light emitted from the homogenizing elements 324A, 324B, respectively. The respective beamsplitters 326A, 326B direct the linearly polarized light 318A, 318B to a first liquid crystal on silicon (LCOS) panel 328A and a second LCOS panel 328B, respectively. The first and second LCOS panels 328A, 328B are front lit. Collimated light leaves the first and second LCOS panels 328A, 328B and is incident upon the in-coupling diffractive optics IDOA, IDOB, respectively. In other words, the image source 18C includes two imaging engines comprising the LCOS panels 328A, 328B that are configured to receive light generated by a single light source system 19. In one or more example embodiments, imaging optics may be provided downstream of the LCOS panels 328A, 328B. As LCOS panels are typically polarization-sensitive, in some examples, some form of retarder or waveplate can be positioned between the polarizing beam splitter 310 and one of the LCOS panels, e.g., 328A or 328B, to optimize the orientation of the linear polarization of one portion of the light exiting the polarizing beam-splitter 310. In this way, both portions of linearly polarized light will be oriented for optimal engagement with both LCOS panels.

Advantageously, this design provides two display panels illuminated by one (polychromatic) light source system 19 (e.g., light source 302A, 302B, 302C) and light of each polarization is utilized by sending linearly polarized light 318A, 318B to two respective LCOS panels 328A, 328B, thereby increasing system efficiency. In an example embodiment, a quarter wave plate 330A, 330B is utilized to align polarization of the light emitted by one or more of the panels 328A, 328B with the diffractive features of the in-coupling diffractive optics IDOA, IDOB to increase overall coupling efficiency within the waveguide 102. As mentioned above LCOS panels are typically polarization-sensitive. This means that, upon engaging with a polarizing beam splitter, most image sources are only utilizing half of the potential light intensity generated by the light source system, while the other portion of linearly polarized light is not used by the system. The example configurations described herein allow for use of both linearly polarized portions of light by using one portion of linearly polarized light through a first LCOS panel 328A and the second portion of oppositely-polarized, linearly-polarized light through a second LCOS panel 328B. Hence, the example configurations described above allow for utilization of all or most of the light generated by the light source system 19. This example configuration results in the potential for double the out-coupling efficiency without doubling the power-requirements of the system.

In another embodiment, the first and second LCOS panels 328A, 328B are replaced by digital light processing (DLP) projectors. Advantageously, this design does not require the unpolarized light 308 to be polarized by the polarizing beam splitter 310, and therefore may utilize a beam splitter to direct light in two optical paths.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. An image light guide for conveying a virtual image, comprising:
a first surface and an opposing second surface;
a first in-coupling diffractive optic arranged along one of the first surface and the second surface, wherein the first in-coupling diffractive comprises a first set of diffractive features;
a second in-coupling diffractive optic arranged along one of the first surface and the second surface, wherein the second in-coupling diffractive comprises a second set of diffractive features, and
an out-coupling diffractive optic arranged along at least one of the first surface and the second surface, wherein the out-coupling diffractive optic comprises a plurality of zones each having a set of diffractive features different than an adjacent zone, wherein the plurality of zones includes a first zone optimized to diffract in-coupled light from the first and second in-coupling diffractive optics.

2. The image light guide according to claim 1, wherein the out-coupling diffractive optic comprises the first zone, a second zone arranged outward of the first zone in a first direction, a third zone arranged outward of the second zone in the first direction, a fourth zone arranged outward of the first zone in a second direction, and a fifth zone arranged outward of the fourth zone in the second direction.

3. The image light guide according to claim 2, wherein the second zone and the fourth zone are mirrored across the first zone, and the third zone and the fifth zone are mirrored across the first zone.

4. The image light guide according to claim 3, wherein the second and fourth zones are rectilinear and oriented at opposite angles relative to an imaginary axis bisecting the first zone.

5. The image light guide according to claim 1, wherein the first zone comprises linear diffractive features orientated parallel with an imaginary axis arranged to bisect the first surface and is parallel with the first surface, wherein the imaginary axis extends between a first edge of the first surface adjacent to the first in-coupling diffractive optic and the second in-coupling diffractive optic and a second edge of the first surface adjacent to the out-coupling diffractive optic.

6. The image light guide according to claim 5, wherein the third zone comprises linear diffractive features oriented at a first angle relative to the diffractive features of the first zone, and the fifth zone comprises linear diffractive features oriented at a second angle relative to the diffractive features of the first zone.

7. The image light guide according to claim 6, wherein the second angle is equal and opposite the first angle.

8. The image light guide according to claim 6, wherein the second zone comprises a first set of linear diffractive features parallel with the diffractive features of the first zone, and a second set of linear diffractive features parallel with the diffractive features of the third zone.

9. The image light guide according to claim 6, wherein the fourth zone comprises a first set of linear diffractive features parallel with the diffractive features of the first zone, and a second set of linear diffractive features parallel with the diffractive features of the fifth zone.

10. The image light guide according to claim 6, wherein the second zone comprises diffractive features having a first grating vector parallel with a grating vector of the first zone, and a second grating vector parallel with a grating vector of the third zone; and
wherein the fourth zone comprises diffractive features having a first grating vector parallel with the grating vector of the first zone, and a second grating vector parallel with a grating vector of the fifth zone.

11. The image light guide according to claim 2, wherein the first, second, third, and fourth zones of the out-coupling diffractive optic form a first output region optimized to diffract image-bearing light beams in-coupled by the first in-coupling diffractive optic, and the first, second, fourth, and fifth zones of the out-coupling diffractive optic form a second output region optimized to diffract image-bearing light beams in-coupled by the second in-coupling diffractive optic.

12. An image source for generating angularly encoded image-bearing light beams, comprising:
a light source system;
a first beam splitter having two opposing output sides through which polarized portions of light exit the polarizing beam splitter, wherein the polarizing beam splitter is operable to polarize light from the light source system into a first optical path and a second optical path;
a second beamsplitter arranged in the first optical path to receive light emitted from the first beam splitter, and a third beamsplitter arranged in the second optical path to receive light emitted from the first beam splitter; and
a first imaging engine arranged in the first optical path to receive light from the second beamsplitter, and a second imaging engine arranged in the second optical path to receive light from the third beamsplitter.

13. The image source according to claim 12, wherein the light source system comprises:
a first wavelength source, a second wavelength source, and a third wavelength source, wherein the first, second, and third wavelength sources are operable to emit light incident upon the first beam splitter.

14. The image source according to claim 13, wherein the light source system comprises lenses arranged between the wavelength sources, respectively, to collimate light emitted thereby.

15. The image source according to claim 12, wherein the first beam splitter comprises a polarizing beam splitter operable to split unpolarized light from the light source system into linearly polarized light.

16. The image source according to claim 12, further comprising a first prism arranged in the first optical path, and a second prism arranged in the second optical path; wherein the first and second prisms are operable to direct the polarized light along the first and second optical paths, respectively.

17. The image source according to claim 12, wherein the first and second imaging engines comprise liquid crystal on silicon (LCOS) panels.

18. The image source according to claim 17, wherein the LCOS panels are front lit.

19. The image source according to claim 12, wherein the first and second imaging engines comprise digital light processing (DLP) projectors.

20. The image source according to claim 17, further comprising a first wave plate arranged to reorient polarization of light emitted by the first imaging engine, and a second wave plate arranged to reorient polarization of light emitted by the second imaging engine.
